(19) United States
(12) Patent Application Publication
(10) Pub. No.: US 2026/0131710 A1
(43) Pub. Date: May 14, 2026

(54) INTEGRATED AIRCRAFT SEAT PROTECTION AND OBJECT RETRIEVAL SYSTEM AND METHOD OF OPERATION THEREOF

(71) Applicant: Mirza Faizan, Plano, TX (US)

(72) Inventors: Mirza Faizan, Plano, TX (US); Shalaan Umar, Plano, TX (US); Nethra Reddy Adama, Plano, TX (US); Joseph Jacob Kurian, Plano, TX (US); Ariv Kiran, Plano, TX (US); Kaashvi Chandra Singh, Plano, TX (US); Jude Jacob, Plano, TX (US); Eashaan Dispenza, Plano, TX (US); Hassan Kalyani, Plano, TX (US); Ali Ahmed Shaikh, Plano, TX (US); Pramiti Neorah Navakiran B, Plano, TX (US); Saadia Asaf, Aligarh (IN); Mansoor Hasan Khan, Aligarh (IN); Sheik Ahamed Azigar Ali, Plano, TX (US); Aliza Asim, Plano, TX (US)

(21) Appl. No.: 18/947,801

(22) Filed: Nov. 14, 2024

(51) Int. Cl. B60N 2/90; B64D 11/06

(52) U.S. Cl. CPC B60N 2/90; B64D 11/06

(57) ABSTRACT

A system for recovering objects fallen into a gap between an aircraft seat and an adjacent structure is provided. The system comprises a sensor array disposed on aircraft floor below the aircraft seat configured to detect an object fallen into the gap, a control cover configured to slide over seat adjustment controls of the aircraft seat, a vibrating guide surface positioned in an area beneath the aircraft seat configured to facilitate movement of the fallen object out of the gap, and a processing unit configured to receive a signal from the sensor array indicating detection of the object fallen in the gap, activate the control cover to slide over the seat adjustment controls in response to the signal, and deactivate the control cover to retract back from the seat adjustment controls when the fallen object moves out of the gap via the vibrating guide surface.

### TECHNICAL FIELD

This disclosure relates generally to an aircraft interior safety system, and more particularly to an integrated aircraft seat protection and object retrieval system. Furthermore, the disclosure relates to a method of operation of an integrated aircraft seat protection and object retrieval system.

### BACKGROUND

In modern aircraft, particularly those used for commercial travel, passenger comfort and convenience are important priorities. However, the limited space between airplane seats and the aircraft wall creates a narrow gap that often leads to problems when small objects, such as mobile phones, personal electronic devices, wallets, or keys, inadvertently fall into it. Such issue may occur frequently during boarding, in-flight movement, or while passengers adjust their seats, and the consequences can lead to various operational and safety concerns for both passengers and the airline crew.

When a mobile phone or other object falls into the gap between the seat and the wall, multiple problems may arise. One of the main concerns is seat control obstruction. In many aircraft, the seat controls are located near this gap, and an object lodged in this space can interfere with the seat's movement mechanism. Such obstruction can prevent the seat from reclining or returning to its upright position, causing discomfort to the passenger. Additionally, forcing the seat to move while an object is stuck can result in damage to both the seat controls and the internal mechanisms of the seat.

There is also a significant safety concern related to potential fire hazards. Many modern mobile phones and electronic devices contain lithium-ion batteries, which are prone to overheating or even catching fire if damaged. If a phone becomes trapped in the seat gap and is crushed or punctured during seat adjustment, the battery could rupture, posing a serious fire hazard inside the aircraft cabin. Such risk endangers both passengers and crew, highlighting the critical nature of addressing this issue.

Furthermore, when personal electronic devices fall into the gap and become trapped, they often sustain considerable damage. Retrieving objects from the gap also proves to be a difficult task. The confined space and limited visibility make it challenging for passengers or crew to locate and extract the object, sometimes requiring special tools or maintenance assistance, which can cause delays and inconvenience.

Furthermore, there is also the potential risk of interference with aircraft systems. Should a device become wedged near critical aircraft electronics, it could potentially interfere with onboard equipment. Although modern aircraft are designed to mitigate electromagnetic interference, the unpredictable nature of a device lodged in an unknown location could still pose a threat. Additionally, the process of retrieving a fallen object often requires passengers to twist or bend into awkward positions, increasing the risk of injury.

Existing solutions, such as pouches or small containers for electronic devices, do little to prevent accidental drops into the seat gap. Moreover, current aircraft seat designs do not detect the presence of an object in the gap and automatically take protective measures or aid in the object's retrieval.

Therefore, there is a need for a mechanism or system that can effectively detect when an object has fallen into the gap between the airplane seat and adjacent wall, prevents damage to the aircraft seat or the fallen object while facilitating safe recovery of the object.

### SUMMARY OF INVENTION

According to first aspect, a system for recovering objects fallen into a gap between an aircraft seat and an adjacent structure is disclosed. The system includes a sensor array, a control cover, a vibrating guide surface, and a processing unit. The sensor array is disposed on aircraft floor below the aircraft seat, configured to detect an object fallen into the gap. The control cover is configured to slide over seat adjustment controls of the aircraft seat. The vibrating guide surface is positioned in an area beneath the aircraft seat. The vibrating guide surface comprises a plurality of bristles that are configured to facilitate movement of the fallen object out of the gap. The processing unit is communicably coupled to the sensor array, and the control cover. The processing unit is configured to receive a signal from the sensor array indicating detection of the object fallen in the gap, activate the control cover to slide over the seat adjustment controls in response to the signal, and deactivate the control cover to retract back from the seat adjustment controls when the fallen object moves out of the gap via the vibrating guide surface.

In an embodiment, the sensor array may comprise a plurality of ultrasonic sensors.

In an embodiment, the sensor array may be configured to continuously monitor the gap and the area beneath the aircraft seat for presence of the fallen object.

In an embodiment, the processing unit may be further configured to determine a real-time position of the object fallen in the gap.

In an embodiment, the control cover may further comprise a display unit communicably coupled to the processing unit.

In an embodiment, the display unit may be configured to display the real-time position of the object fallen in the gap.

In an embodiment, the system further comprises a motor operatively coupled to the control cover configured to activate and deactivate the control cover to slide over the seat adjustment controls and retract back from the seat adjustment controls respectively.

In an embodiment, the motor may be further configured to prevent manual retraction of the control cover from the seat adjustment controls, when the control cover is activated.

In an embodiment, the plurality of bristles may be oriented at a predetermined angle of inclination to form a designated path to facilitate movement of the fallen object out of the gap via the designated path

In an embodiment, the plurality of bristles may be arranged in a predetermined density to facilitate movement of the fallen object out of the gap via the designated path.

In an embodiment, the plurality of bristles may have a predetermined height to facilitate movement of the fallen object out of the gap via the designated path.

In an embodiment, the plurality of bristles may have a predetermined thickness to facilitate movement of the fallen object out of the gap via the designated path.

In an embodiment, the plurality of bristles may be made of a lightweight material selected from the group comprising of plastic and aero graphite.

In an embodiment, the vibrating guide surface may be engaged with aircraft body to harness vibrations of the aircraft body, when the aircraft is in motion, to facilitate movement of the fallen object out of the gap.

In an embodiment, the vibrating guide surface may be further engaged with a vibration motor configured to generate vibrations, when the aircraft is stationary, to facilitate movement of the fallen object out of the gap.

In an embodiment, the processing unit may be communicably coupled to the vibration motor and may be configured to activate the vibration motor to generate vibrations when the aircraft is stationary, to facilitate movement of the fallen object out of the gap.

In an embodiment, the vibrating guide surface maybe sloped in a particular direction to facilitate movement of the fallen object out of the gap.

In an embodiment, the system may further comprise a wireless communication unit configured to transmit an alert to an external device upon detection of the fallen object into the gap.

According to second aspect, a method of operation of system for recovering objects fallen into a gap between an aircraft seat and an adjacent structure is disclosed. The method includes steps of: detecting, via a sensor array, an object fallen into the gap between the aircraft seat and the adjacent structure; transmitting a signal from the sensor array to a processing unit upon detection of the object fallen into the gap; activating, in response to the signal, a control cover to slide over seat adjustment controls; utilizing a vibrating guide surface positioned in an area beneath the aircraft seat comprising a plurality of bristles that are configured to facilitate movement of the fallen object out of the gap; and deactivating the control cover to retract back from the seat adjustment controls when the fallen object moves out of the gap via the vibrating guide surface.

In an embodiment, the method further includes activating a vibration motor configured to generate vibrations, when the aircraft is stationary, to facilitate movement of the fallen object out of the gap.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a block diagram of a system for recovering objects fallen into a gap between an aircraft seat and an adjacent structure, in accordance with first aspect of the present disclosure.

FIG. 2 illustrates a perspective view of an aircraft seating environment installed with the system of FIG. 1, in accordance with an embodiment of the present disclosure.

FIG. 3 illustrates a top view of a control cover sliding over seat adjustment controls, in accordance with an embodiment of the present disclosure.

FIG. 4 illustrates a side view of a vibrating guide surface, in accordance with an embodiment of the present disclosure.

FIG. 5 illustrates a block diagram of a system for recovering objects fallen into a gap between an aircraft seat and an adjacent structure, in accordance with an embodiment of the present disclosure.

FIG. 6 illustrates a flow chart a method of operation for recovering objects fallen into a gap between an aircraft seat and an adjacent structure, in accordance with second aspect of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

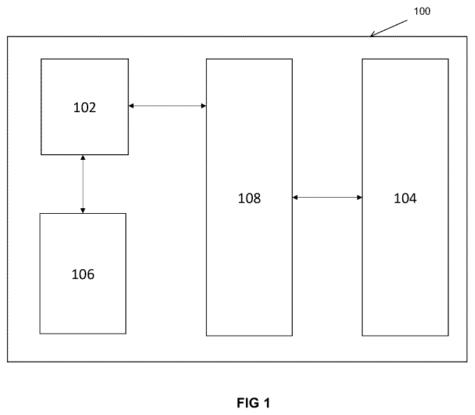

Referring to FIG. 1, which illustrates a block diagram of a system 100 for recovering objects fallen into a gap between an aircraft seat and an adjacent structure, in accordance with first aspect of the present disclosure. The system 100 comprises a sensor array 102 disposed on aircraft floor below the aircraft seat, configured to detect an object fallen into the gap. Furthermore, the system 100 comprises a control cover 104 configured to slide over seat adjustment controls of the aircraft seat. Furthermore, the system 100 comprises a vibrating guide surface 106 positioned in an area beneath the aircraft seat, wherein the vibrating guide surface comprises a plurality of bristles that are configured to facilitate movement of the fallen object out of the gap. Furthermore, the system 100 comprises a processing unit 108 communicably coupled to the sensor array 102, and the control cover 104. The processing unit 108 is configured to receive a signal from the sensor array 102 indicating detection of the object fallen in the gap, activate the control cover 104 to slide over the seat adjustment controls in response to the signal, and deactivate the control cover 104 to retract back from the seat adjustment controls when the fallen object moves out of the gap via the vibrating guide surface 106.

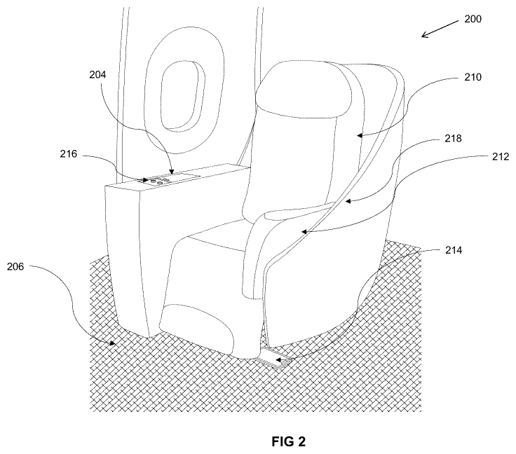

FIG. 2 illustrates a perspective view of an aircraft seating environment 200 installed with the system 100 (not shown in Figure), in accordance with an embodiment of the present disclosure. The aircraft seating environment 200 comprises the aircraft seat 210 and the adjacent structure 218. The aircraft seat 210 and the adjacent structure 218 forms the gap 212. The sensor array 102 (not shown in Figure) of the system 100 is disposed on aircraft floor below the aircraft seat 210, configured to detect the object 214 fallen into the gap 212. The aircraft seat environment 200 comprises the vibrating guide surface 206 positioned in the area beneath the aircraft seat 210 and in the surrounding surface area around the aircraft seat 210. The vibrating guide surface 206 is configured to facilitate movement of the fallen object 214 out of the gap 212. The aircraft seat environment 200 comprises control cover 204 configured to slide over seat adjustment controls 216 of the aircraft seat 210. The control cover 204 is activated to slide over the seat adjustment controls 216 in response to detection of the fallen object 214 in the gap 212. Furthermore, the control cover 204 is deactivated to retract back from the seat adjustment controls 216 when the fallen object 214 moves out of the gap 212 via the vibrating guide surface 206.

Referring now to FIGS. 1 and 2, the system 100 is advantageous in terms of preventing any fire hazard due to crushing of electronic devices fallen into the gap 212 of the aircraft seat 210 and the adjacent structure 218. Furthermore, the system 100 reduces risk of damage to the aircraft seat 210 due to fallen object 214.

In an embodiment, the sensor array 102 comprises a plurality of ultrasonic sensors. Beneficially, the plurality of ultrasonic sensors are disposed on aircraft floor below the aircraft seat to accurately detect the fallen object 214. The ultrasonic sensors may enable accurate, fast and versatile non-contact detection in confined spaces. In an alternative embodiment, the sensor array 102 may include infrared sensors, capacitive sensors, optical sensors, pressure sensitive sensors, microwave sensors, weight sensors, laser sensors, computer vision sensors and so on. It is to be understood that the person skilled in the art may utilize any type of suitable sensors.

In an embodiment, the sensor array 102 is configured to continuously monitor the gap 212 and the area beneath the aircraft seat 210 for presence of the fallen object 214. Beneficially, the continuous monitoring of the gap 212 may enable operation of the control cover 104. It is to be understood that the control cover 104 is deactivated once the fallen object 214 moves out of the gap 212. It is to be understood that the sensor array 102 continuously detect the changing position of the fallen object 214.

In an embodiment, the processing unit 108 is configured to determine a real-time position of the object 214 fallen in the gap 212. It is to be understood that the real-time position of the object 214 fallen in the gap 212 is determined by the continuous monitoring of the gap 212 and the area beneath the aircraft seat 210 for presence of the fallen object 214. The real-time position of the object 214 fallen in the gap 212 may be communicated to a user (including an occupant of the seat, a flight crew and so on).

In an embodiment, the sensor array 102 may communicate with the processing unit 108 wirelessly or through wired communication. A battery (not illustrated in FIG. 1 or FIG. 2) may be provided with the system 100 to supply electrical power to the sensor array 102 and the processing unit 108.

The processing unit 108 may include suitable logic, circuitry, and interfaces that may be configured to execute program instructions associated with a set of operations to be executed to determine weight distribution, provide the output signal or control the speaker, the display screen, or the haptic device. The processing unit 108 may include one or more processing units, which may be implemented as an integrated processor or a cluster of processors that perform the functions of the one or more processing units, collectively. The processing unit 108 may be implemented based on a number of processor technologies known in the art. Example implementations of the processing unit 108 may include, but are not limited to, an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

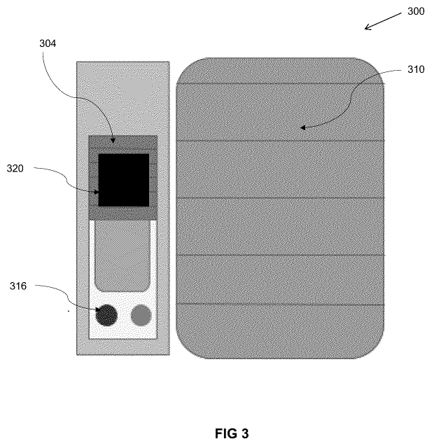

FIG. 3 illustrates a top view of the aircraft seat environment 300 with aircraft seat 310 seat adjustment controls 316, in accordance with an embodiment of the present disclosure. The processing unit 108 activates the control cover 304 to slide over the seat adjustment controls 316. Furthermore, the processing unit 108 deactivates the control cover 304 to retract back from the seat adjustment controls 316. As explained above, the sensor array 102 is configured to continuously monitor the gap 212 and the area beneath the aircraft seat 210 for presence of the fallen object 214 to determine whether the fallen object 214 has moved out of the area beneath the aircraft seat 210. The processing unit 108 deactivates the control cover 304 to retract back from the seat adjustment controls 316 when the fallen object 214 moves out of the gap 212 via the vibrating guide surface 106.

In an embodiment, the control cover comprises a display unit 320 communicably coupled to the processing unit 108. The display unit 320 may be realized through several known technologies such as, but not limited to, a Liquid Crystal Display (LCD) display, a Light Emitting Diode (LED) display, a plasma display, and/or an Organic LED (OLED) display technology, and/or other display technologies. The display unit 320 may further be configured to receive user inputs. It is to be understood that the user inputs may include manual override instructions to deactivate the control cover 304.

In an embodiment, the display unit 320 is configured to display the real-time position of the object 214 fallen in the gap 212. Beneficially, the real-time position of the object 214 fallen in the gap 212 is displayed to the user enabling the user to take retrieval decisions. In an example, the user may decide location of retrieval of the object 214 based on the real-time location of the object 214.

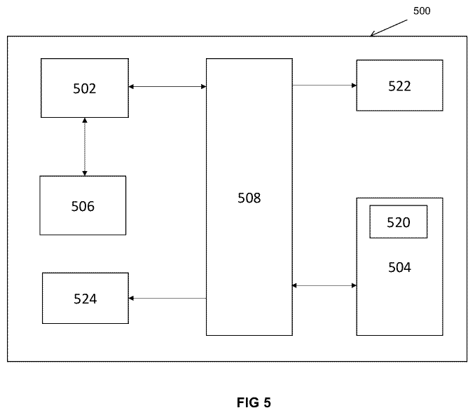

In an embodiment, the system 100 further comprises a motor 520 (shown in FIG. 5) operatively coupled to the control cover 304 configured to activate and deactivate the control cover 304 to slide over the seat adjustment controls 316 and retract back from the seat adjustment controls 316 respectively. It is to be understood that the motor 520 enables movement of the control cover 304 over the seat adjustment controls 316. The motor 520 may include stepper motor, servo motor, linear actuator, piezoelectric motor and so on. The motor 520 may be mechanically engaged with the control cover 304.

In an embodiment, the motor 520 is configured to prevent manual retraction of the control cover 304 from the seat adjustment controls 316, when the control cover 304 is activated. It is to be understood that the motor 520 may apply a constant torque on the control cover 304 to prevent manual retraction of the control cover 304 from the seat adjustment controls 316.

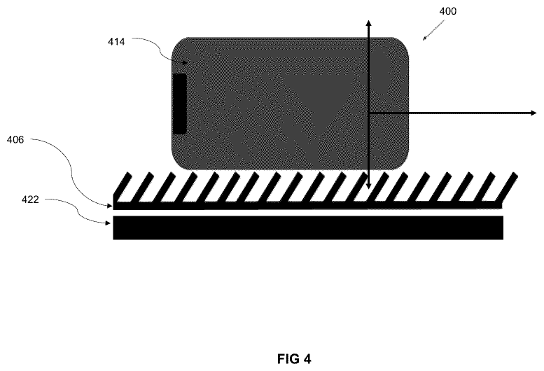

FIG. 4 illustrates a side view of a vibrating guide surface 406 forming an object movement surface 400, in accordance with an embodiment of the present disclosure. The vibrating guide surface 406 is positioned in the area beneath the aircraft seat 210. The vibrating guide surface 406 comprises the plurality of bristles that are configured to facilitate movement of the fallen object 414 (shown as object 214 in FIG. 2) out of the gap 212.

In an embodiment, the plurality of bristles are oriented at a predetermined angle of inclination to form a designated path to facilitate movement of the fallen object 214 out of the gap 212 via the designated path. It is to be understood that the angle of inclination along with the interaction of various forces acting on the object 214 results in net force on the object 214 acting in the direction of the inclination of the plurality of bristles. The plurality of bristles may enable formation of a resultant force vector on the object 214 to enable movement of the object 214 out of the gap 212. In an embodiment, the angle of orientation of the plurality of bristles may be predetermined based on the factors such as friction, gravity, vibration amplitude, object properties, gap dimensions, bristle material and so on. In a preferred embodiment, the angle of inclination of the plurality of bristles may be in range of 25 degree to 65 degree with reference to vibrating guide surface 406.

In an embodiment, the plurality of bristles are arranged in a predetermined density to facilitate movement of the fallen object out of the gap via the designated path. In an embodiment, the density of the plurality of bristles may be predetermined based on the factors such as object support, vibration transmission, airflow and so on. In a preferred embodiment, the density of the plurality of bristles may be in range of 31 to 62 bristles per square cm of surface area.

In an embodiment, the plurality of bristles have a predetermined height to facilitate movement of the fallen object out of the gap via the designated path. In an embodiment, the height of the plurality of bristles may be predetermined based on the factors such as gap height, flexibility of the bristles, object size, vibration amplitude and so on. In a preferred embodiment, the height of the plurality of bristles may be in range of 15 to 25 mm.

In an embodiment, the plurality of bristles have a predetermined thickness to facilitate movement of the fallen object out of the gap via the designated path. In an embodiment, the thickness of the plurality of bristles may be predetermined based on factors such as flexibility, durability, object interaction and so on. In an preferred embodiment, the thickness of the plurality of bristles may be in range of 0.5 to 1 mm.

In an embodiment, the plurality of bristles are made of a lightweight material selected from the group comprising of plastic and aero graphite. Alternatively, the plurality of bristles may be made of any other suitable material.

In an embodiment, the vibrating guide surface 406 is engaged with aircraft body to harness vibrations of the aircraft body (not shown in FIG. 2), when the aircraft is in motion, to facilitate movement of the fallen object out of the gap. Beneficially, the motion of the aircraft may generate enough vibrations to create the resultant force vector on the object 214 to enable movement of the object 214 out of the gap 212.

In an embodiment, the vibrating guide surface 406 is engaged with a vibration motor 422 configured to generate vibrations, when the aircraft is stationary, to facilitate movement of the fallen object out of the gap. Beneficially, the vibration motor 422 may generate enough vibrations to create the resultant force vector on the object 214 to enable movement of the object 214 out of the gap 212, when the aircraft is stationary. In a preferred embodiment, the vibration motor 422 may be a linear vibration motor. In an alternative embodiment, the vibration motor 422 may be any suitable vibration motor.

In an embodiment, the processing unit 108 is communicably coupled to the vibration motor 422 and configured to activate the vibration motor 422 to generate vibrations when the aircraft is stationary, to facilitate movement of the fallen object 214 out of the gap 212. In an embodiment, the processing unit 108 may determine that the position of the object 214 is not changing and activate the vibration motor 422 to generate vibrations irrespective of whether the aircraft is stationary or in motion.

In an embodiment, the vibrating guide surface 406 is sloped in a particular direction to facilitate movement of the fallen object 214 out of the gap 212. In a preferred embodiment, the vibrating guide surface 406 is sloped towards an area easily accessible to the user for easy retrieval of the object 214.

FIG. 5 illustrates a block diagram of the system 400 for recovering objects 214 (as shown in FIG. 2) fallen into the gap 212 between the aircraft seat 210 and an adjacent structure 218, in accordance with an embodiment of the present disclosure. With reference to the FIG. 1 and FIG. 2, the system 500 comprises the sensor array 502 disposed on aircraft floor below the aircraft seat 210, configured to detect the object 214 fallen into the gap 212. Furthermore, the system 500 comprises a control cover 504 configured to slide over seat adjustment controls 216 of the aircraft seat 210. Furthermore, the system 500 comprises the vibrating guide surface 506 positioned in the area beneath the aircraft seat 210, wherein the vibrating guide surface 506 comprises the plurality of bristles that are configured to facilitate movement of the fallen object 214 out of the gap 212. Furthermore, the system 500 comprises the processing unit 508 communicably coupled to the sensor array 502, and the control cover 504. The processing unit 508 is configured to receive the signal from the sensor array 502 indicating detection of the object 214 fallen in the gap 212, activate the control cover 504 to slide over the seat adjustment controls 216 in response to the signal, and deactivate the control cover 504 to retract back from the seat adjustment controls 216 when the fallen object 214 moves out of the gap 212 via the vibrating guide surface 506. Furthermore, the processing unit 508 is communicably coupled to the vibration motor 522 and configured to activate the vibration motor 522. In an embodiment, the system 500 further comprises a wireless communication unit 524 configured to transmit an alert to an external device upon detection of the fallen object 214 into the gap 212. In an embodiment, the external device may be a pilot information system, a crew information system and so on. The external device may be capable of receiving and displaying information. Beneficially, the external device may alert a pilot or a crew member of the aircraft regarding the falling of the object 214.

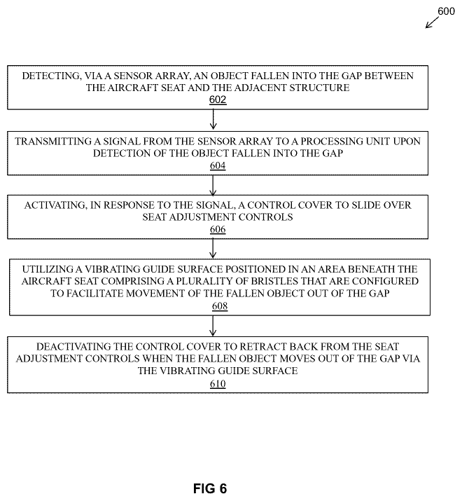

FIG. 6 is a flowchart that illustrates an example of a method of operation of system for recovering objects fallen into a gap between an aircraft seat and an adjacent structure, in accordance with an embodiment of the disclosure. FIG. 6 is explained in conjunction with elements from FIGS. 1-5. With reference to FIG. 6, there is shown a flowchart 600. The operations from 602 to 610 may be implemented by any computing system. The operations may start at 602 and may proceed to 610.

At 602, the method comprises detecting, via a sensor array, an object fallen into the gap between the aircraft seat and the adjacent structure.

At 604, the method comprises transmitting a signal from the sensor array to a processing unit upon detection of the object fallen into the gap.

At 606, the method comprises activating, in response to the signal, a control cover to slide over seat adjustment controls.

At 608, the method comprises utilizing a vibrating guide surface positioned in an area beneath the aircraft seat comprising a plurality of bristles that are configured to facilitate movement of the fallen object out of the gap.

At 610, the method comprises deactivating the control cover to retract back from the seat adjustment controls when the fallen object moves out of the gap via the vibrating guide surface.

In an embodiment, the method 600 comprises activating a vibration motor configured to generate vibrations, when the aircraft is stationary, to facilitate movement of the fallen object out of the gap.

Although the flowchart 600 is illustrated as discrete operations, such as 602, 604, 606, 608 and 610 the disclosure is not so limited. Accordingly, in certain embodiments, such discrete operations may be further divided into additional operations, combined into fewer operations, or eliminated, depending on the implementation without detracting from the essence of the disclosed embodiments.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A system for recovering objects fallen into a gap between an aircraft seat and an adjacent structure, wherein the system comprises:
a sensor array disposed on aircraft floor below the aircraft seat, configured to detect an object fallen into the gap;
a control cover configured to slide over seat adjustment controls of the aircraft seat;
a vibrating guide surface positioned in an area beneath the aircraft seat, wherein the vibrating guide surface comprises a plurality of bristles that are configured to facilitate movement of the fallen object out of the gap; and
a processing unit communicably coupled to the sensor array, and the control cover, wherein the processing unit is configured to:
receive a signal from the sensor array indicating detection of the object fallen in the gap;
activate the control cover to slide over the seat adjustment controls in response to the signal; and
deactivate the control cover to retract back from the seat adjustment controls when the fallen object moves out of the gap via the vibrating guide surface.

2. The system of claim 1, wherein the sensor array comprises a plurality of ultrasonic sensors.

3. The system of claim 1, wherein the sensor array is configured to continuously monitor the gap and the area beneath the aircraft seat for presence of the fallen object.

4. The system of claim 1, wherein the processing unit is configured to determine a real-time position of the object fallen in the gap.

5. The system of claim 1, wherein the control cover comprises a display unit communicably coupled to the processing unit.

6. The system of claim 5, wherein the display unit is configured to display the real-time position of the object fallen in the gap.

7. The system of claim 1, wherein the system further comprises a motor operatively coupled to the control cover configured to activate and deactivate the control cover to slide over the seat adjustment controls and retract back from the seat adjustment controls respectively.

8. The system of claim 7, wherein the motor is configured to prevent manual retraction of the control cover from the seat adjustment controls, when the control cover is activated.

9. The system of claim 1, wherein the plurality of bristles are oriented at a predetermined angle of inclination to form a designated path to facilitate movement of the fallen object out of the gap via the designated path.

10. The system of claim 1, wherein the plurality of bristles are arranged in a predetermined density to facilitate movement of the fallen object out of the gap via the designated path.

11. The system of claim 1, wherein the plurality of bristles have a predetermined height to facilitate movement of the fallen object out of the gap via the designated path.

12. The system of claim 1, wherein the plurality of bristles have a predetermined thickness to facilitate movement of the fallen object out of the gap via the designated path.

13. The system of claim 1, wherein the plurality of bristles are made of a lightweight material selected from the group comprising of plastic and aero graphite.

14. The system of claim 1, wherein the vibrating guide surface is engaged with aircraft body to harness vibrations of the aircraft body, when the aircraft is in motion, to facilitate movement of the fallen object out of the gap.

15. The system of claim 1, wherein the vibrating guide surface is engaged with a vibration motor configured to generate vibrations, when the aircraft is stationary, to facilitate movement of the fallen object out of the gap.

16. The system of claim 14, wherein the processing unit is communicably coupled to the vibration motor and configured to activate the vibration motor to generate vibrations when the aircraft is stationary, to facilitate movement of the fallen object out of the gap.

17. The system of claim 1, wherein the vibrating guide surface is sloped in a particular direction to facilitate movement of the fallen object out of the gap.

18. The system of claim 1, wherein the system further comprises a wireless communication unit configured to transmit an alert to an external device upon detection of the fallen object into the gap.

19. A method of operation of system for recovering objects fallen into a gap between an aircraft seat and an adjacent structure, comprising:
detecting, via a sensor array, an object fallen into the gap between the aircraft seat and the adjacent structure;
transmitting a signal from the sensor array to a processing unit upon detection of the object fallen into the gap;
activating, in response to the signal, a control cover to slide over seat adjustment controls;
utilizing a vibrating guide surface positioned in an area beneath the aircraft seat comprising a plurality of bristles that are configured to facilitate movement of the fallen object out of the gap; and
deactivating the control cover to retract back from the seat adjustment controls when the fallen object moves out of the gap via the vibrating guide surface.

20. The method of claim 19, further comprising activating a vibration motor configured to generate vibrations, when the aircraft is stationary, to facilitate movement of the fallen object out of the gap.
